(19) United States
(12) Patent Application Publication
(10) Pub. No.: US 2002/0161844 A1
(43) Pub. Date: Oct. 31, 2002

(54) Method and apparatus for peer to peer communication over a master slave interface

(76) Inventor: Eric J. Overtoom, Grayslake, IL (US)

Correspondence Address: MOTOROLA INC, 600 NORTH US HIGHWAY 45, LIBERTYVILLE, IL, 60048-5343, US

(21) Appl. No.: 09/793,864

(22) Filed: Feb. 27, 2001

(51) Int. Cl. G06F 15/16

(52) U.S. Cl. 709/208; 709/205

(57) ABSTRACT

A method to establish peer to peer communication in a system utilizing a master-slave protocol which allows a first slave device (504) to act as the master and communicate with a second slave device (506) such as an accessory to the first slave device. The first slave device sends a message comprising a data set and a functional address (608), which represents a function in the second slave device to a host device, which now acts as a router, which then forwards the message on to the second slave device. This allows the slave devices to communicate with one another without direct control by the host or master device.

### BACKGROUND OF THE INVENTION

The present invention relates to computer networking. More particularly it relates to controlling a communication signal by a slave device within a computer network operating under a master-slave protocol.

A very common master-slave protocol is the universal serial bus (USB) protocol. The USB is a high speed serial bus which supports devices such as keyboards, printers, scanners and pointing devices. The USB system has become a standard within the computer industry as this protocol allows for the networking of multiple devices with limited connections and it is user friendly. The system operates typically on the peripheral component interconnect (PCI) bridge but may operate on other host bridges or I/O buses as well.

Under the USB system architecture, two or more devices are interconnected for communication. These devices are generally referred to as USB devices which are defined by hardware and software components within the USB device. There are generally one or more USB devices defined as peripheral or slave devices. Peripherals may be input or output devices. Some examples of common peripherals include printers, modems, scanners or any other device that exchange data with a host computer. Each peripheral device is connected either directly or via a USB hub, to a single host. Transactions occur between the peripherals and the host. The host controls the transactions which are initiated by the USB software. A USB driver will provide the interface between the USB device and the application software in host system (i.e. computer). The general purpose for the USB protocol is to allow simple and quick interconnection between a host computer and peripheral devices.

A system view of the prior art, shown in FIG. 1, illustrates a general USB system and the flow of data from host 102 or master to slave device 104 and if necessary, back from the slave device 104 to the host device 102. The USB protocol requires that the host device 102 control transactions to and from the slave device 104. The host device 102 sends a message to a specific device designated by a physical address. FIG. 2 illustrates the code sequence of the message of the prior art wherein the code is divided into phases; the token phase, the data packet phase and the handshake phase. FIG. 3 shows a detailed view of the data packet phase 300, which is of interest to the present invention. The data packet phase 300 includes the synchronization bit 302, the packet ID 304, the device address 306, the endpoint address 308, the cyclical redundancy check (CRC) 310, and the data 312 intended to be received by the designated address. Cellular radiotelephones or cell phones, have begun to evolve into computer peripherals in order to store and manage data. Cell phones may be connected to a computer for wireless connection to the internet, or to upload or download data to the computer. The transfer of data may be for backup purposes or to synchronize the data between the personal computer and the radiotelephone such as personal information such as address book data or appointment information for example.

The capability of cellular radiotelephones may also be expanded by connecting external accessories to the phone. The accessories are electrically connected allowing data communication between the phone and the accessory. Typically the microprocessor in the phone controls data transactions between the phone and the accessory, extending the control of the microprocessor beyond the physical structure of the phone. Examples of accessories include clip on speaker phone, a personal digital assistant (PDA), or a hands free device. Accessories may be passive, also referred to as dumb, and can only receive information from the cell phone or they may be active, also referred to as smart, wherein the accessory incorporates circuitry to communicate with the phone. Current methods and protocols are slow, limiting both the speed and the type of data communicated with an accessory. Another downfall of current communication protocols is that there isn't one standard method of establishing communication. Therefore an improvement is needed in the communication networking protocol to increase the data rate and allow for a common method of communicating between electronic devices.

Implementation of the USB protocol into radiotelephones allows a simple and quick solution allowing high-speed connectivity to a computer. Under the USB protocol, the cell phone would be defined as a peripheral or slave device controlled by commands from the computer or host. The cell phone is not able to initiate commands, only respond to commands from the host. Using the USB for accessory communication presents a problem as a cell phone must initiate and control the transactions between the accessory devices, whether they are dumb or smart. A separate protocol is therefore necessary to operate the accessories. Currently this requires additional software and this type of accessory operation is not possible under the standard USB protocol as the phone would be required to be a host, which is contrary to ever decreasing size and requirements.

Accordingly there is a need to establish a method for peer to peer communication in a system operating under a master slave protocol, which increases the connectivity of multiple devices to one another, effectuates power management, and provides for authentication of interconnected devices.

### BRIEF DESCRIPTION OF THE DRAWINGS

FIG. 1 is a system view diagram of the prior art illustrating the master slave relationship;

FIG. 2 is represents the general code sequence of the prior art;

FIG. 3 is a detailed representation of the code sequence of the prior art;

FIG. 4 is a block diagram of the cellular radiotelephone in accordance with the preferred embodiment of the present invention;

FIG. 5 is a system view diagram showing the data flow in accordance with the present invention;

FIG. 6 is a block diagram of the system employing the accessory protocol in accordance with the preferred embodiment of the present invention;

FIG. 7 is a representation of the code sequence in accordance with the preferred embodiment of the present invention;

FIG. 8 is a flow chart showing the initialization sequence of an accessory protocol master in accordance with the preferred embodiment of the present invention;

FIG. 9 is a flow chart showing the initialization sequence of an accessory in accordance with the preferred embodiment of the present invention;

FIG. 10 is a flow chart showing the general steps to control a transaction between the accessory protocol master and an accessory;

FIG. 11 is a sequence chart showing the control in transaction in accordance with the preferred embodiment of the present invention;

FIG. 12 is a sequence chart showing the control out transaction in accordance with the preferred embodiment of the present invention;

FIG. 13 is a block diagram of the code sequence from the host perspective (?) in accordance with the preferred embodiment of the present invention.

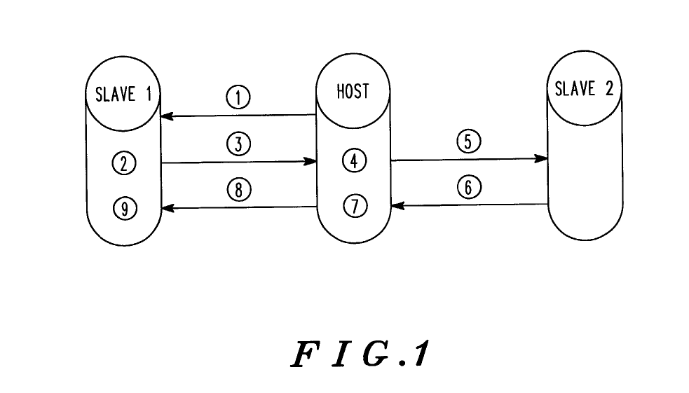

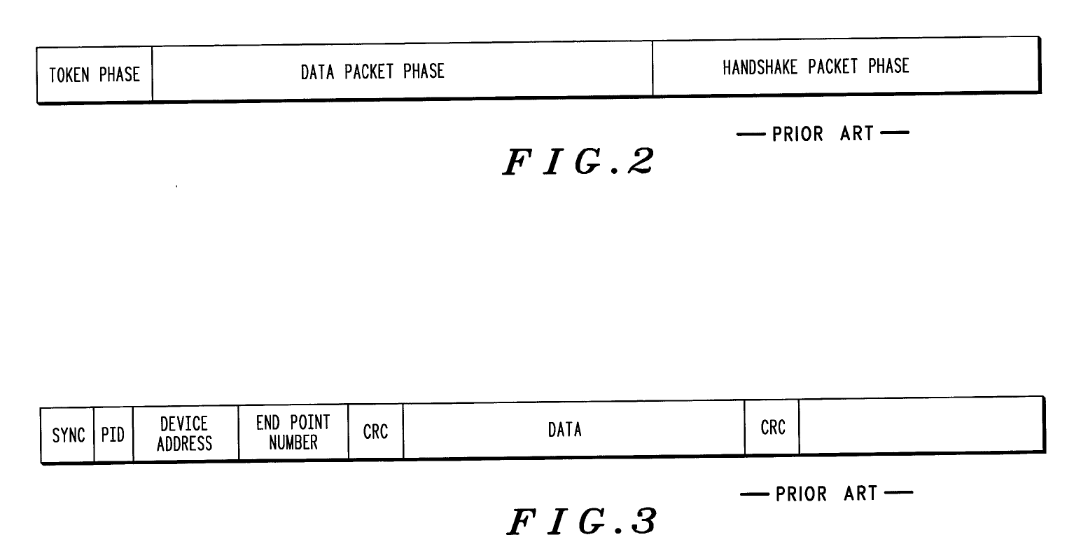

### DETAILED DESCRIPTION OF PREFERRED EMBODIMENTS

The following detailed description is exemplary and exemplary only and is not restrictive of the invention as claimed. The present invention relates to a method for directing communications between slave devices (peer to peer) in a master slave network. More particularly it relates to allowing a slave device to act as a master thereby directly controlling transactions between it and other slave devices.

The present invention is incorporated into a master slave protocol where generally a host acting as a master, controls all of the transactions between it and the slave devices. Transactions under this protocol are not directed between slave devices. The USB protocol is an example of this type of network. Other master slave protocols include Bluetooth™, HDLC to name a few. The preferred embodiment of the present invention overlays an accessory protocol onto the USB protocol allowing a traditional USB slave device, instead of a host to act as a master device for this protocol. In the preferred embodiment of the present invention, a cellular radiotelephone utilizes the USB protocol to communicate with a computer. This is because USB is the standard for computer networking and is easily adapted to radiotelephones for connection thereof. However accessories are commonly connected to radiotelephone and by definition of the USB protocol, a computer, generally a Personal Computer or the like, takes on the master role. This prevents the radiotelephone from communicating with its accessories autonomously. The present invention advantageously allows the radiotelephone to be designated as the accessory protocol master (APM), by the accessory protocol that is overlaid onto the USB protocol. The accessory protocol advantageously gives the radiotelephone the capability to include additional address information into the data packet phase of a USB transaction allowing it to route a data set to another slave device such as a radiotelephone accessory in the preferred embodiment of the present invention. This allows the radiotelephone to control transactions between it and the accessories and the host. A data set routed or sent to the radiotelephone accessory or host may be any of which is described in the USB protocol including control data, requesting data or download data. The type of transfer depends on the type of accessory connected to the cell phone as well as the type of operation desired. Although a radiotelephone is presented as the preferred embodiment of the present invention, any electronic device facilitating a master slave protocol for the interconnection and communication with other devices may incorporate the present invention.

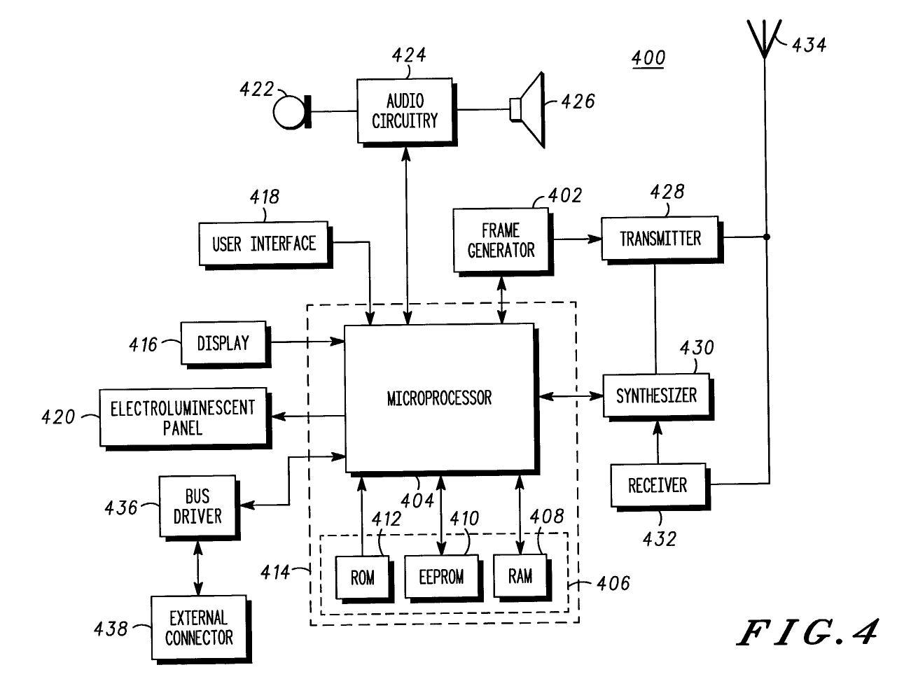

Turning to FIG. 4, a block diagram of a wireless communication device 400 such as a cellular radiotelephone in accordance with the preferred embodiment of the present invention is shown. In the preferred embodiment a frame generator ASIC 402, such as a CMOS ASIC available from Motorola, Inc. and a microprocessor 404, such as a 68HC11 microprocessor also available from Motorola, Inc., combine to generate the necessary communication protocol for operating in a cellular or Personal communication (PCS) system. Microprocessor 404 uses memory 406 comprising RAM 408, EEPROM 410, and ROM 412, preferably consolidated in one package 414, to execute the steps necessary to generate the protocol and to perform other functions for the wireless communication device 400, such as writing to a display 416, accepting information from a user interface 418, controlling a frequency synthesizer 430, controlling communications protocols and the routing of information packets in accordance with the present invention. An I/O bus driver 436, also available from Motorola Inc., controls the input and output of data sets from the external connector 138 to the microprocessor 404. ASIC 404 also processes audio transformed by audio circuitry 424 from a microphone 422 and to a speaker 426. The external connector 438 is used to connect the wireless communication device to external devices such as accessories for the wireless communication device or a personal computer, in accordance with the preferred embodiment of the present invention. The connection to the external devices may also be facilitated by a wireless link as opposed to a physical connector as shown in FIG. 4 such as an infrared link or an RF link such as BlueTooth™ or the like.

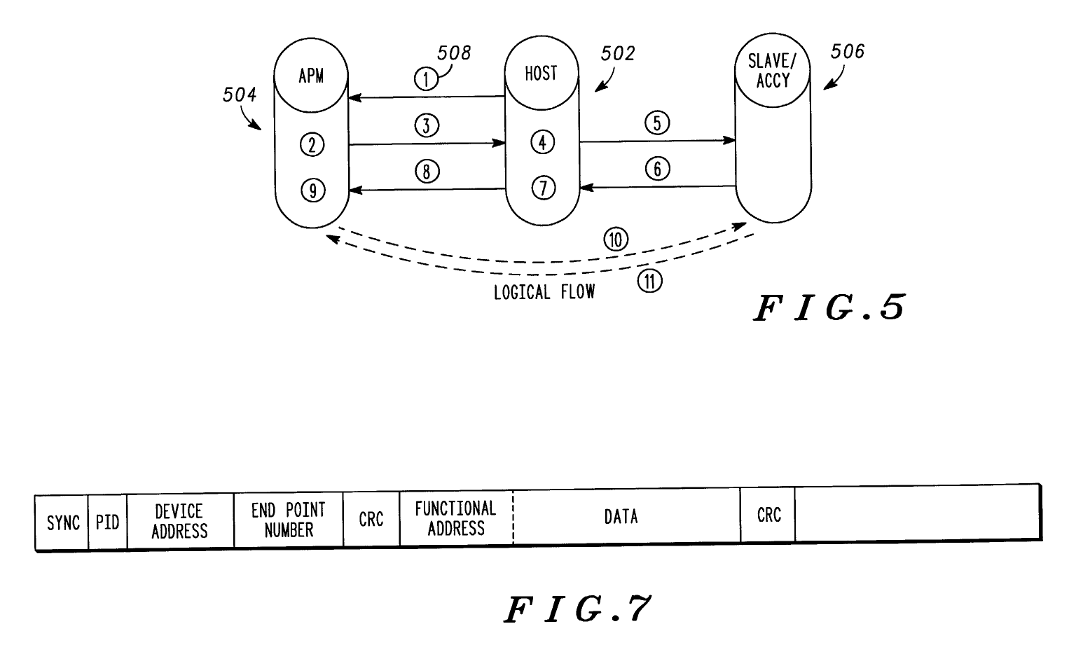

A block diagram representing the data flow of the present invention of the preferred embodiment is shown in FIG. 5, which illustrates the host 502 or the USB master, a first slave 504 device or accessory protocol master (APM), as designated by the invention, and a second slave device 506. The second slave device 406 may be an accessory to the wireless communication device 400 or similar device or a PC. More devices may be coupled to the APM 502, but only one is shown for illustrative purposes. FIG. 4 further shows the actual and the logical data flow between the APM 502 and the second slave devices. The actual data flow (the physical route that the data takes through the system) is indicated by solid lined arrows (1 through 9) while the logical data flow, (the route from originating device to the intended recipient device) is indicated by hatched line arrows (10 and 11). For example, when the APM 504 wants to send a data set to the second slave device 506, the logical flow of the data set in a first transaction 508 originates at the APM 504 and is received by the second slave device 506. The actual data flow is from the APM 504 to the host 502, acting as a router, and finally to the second slave device 506. In some cases the APM 504 may want to communicate with the host and the logical flow is from the APM 504 to the host 502.

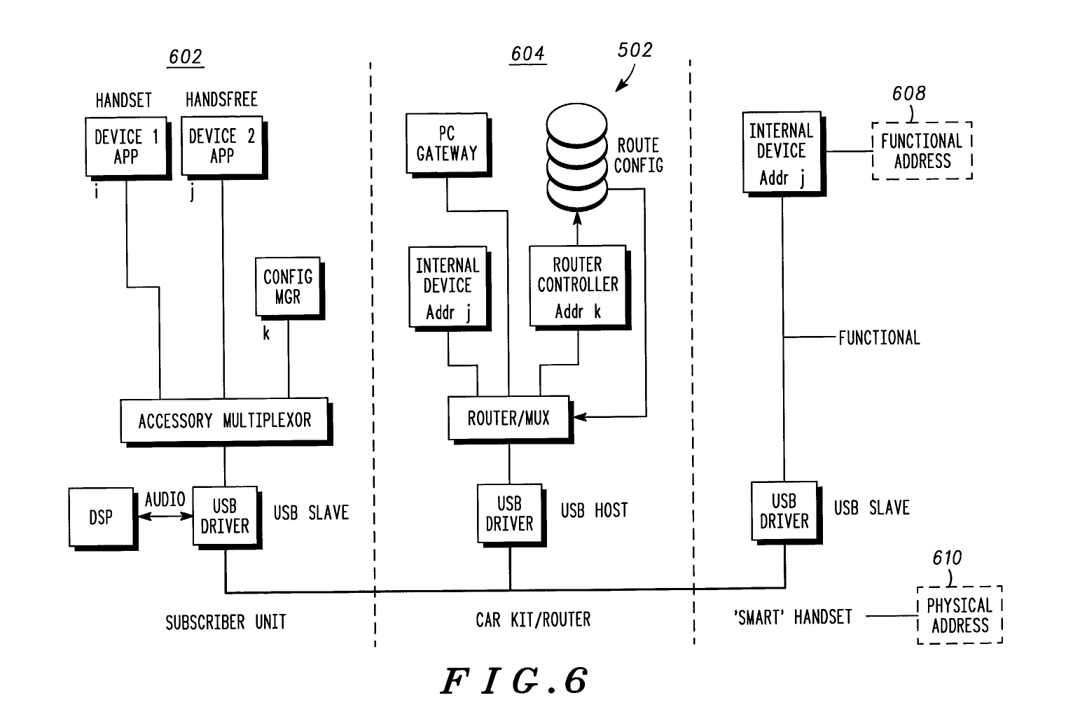

Looking to FIG. 6, a radiotelephone 602 in accordance with the preferred embodiment of the present invention is shown with hands free car kit 604 and a ‘smart’ handset 606. In the preferred embodiment of the present invention the radiotelephone 602 is advantageously designated as the APM 504 as it is the primary device as most transaction requests will originate at or be the main object of its operation. In order for the APM 504 to direct a transaction to the intended slave device or smart handset 606 in accordance with the preferred embodiment of the present invention, a second logical or functional address 608 is assigned to a register in the smart handset 606. Multiple functional addresses may be assigned to one device in accordance with the present invention, representing different functions, behaviors, operations or storage locations within the device, however one is represented here from simplicity. The functional address 608 advantageously further extends the operation of the USB protocol such that multiple “virtual” devices each represented by a unique functional address 608 may reside within one physical device. Therefore a function address 608 or plurality thereof is associated with one physical device.

In current radiotelephone systems the radiotelephone acts as the master or host and controls the accessory. Because the USB protocol does not allow this, the present invention accordingly designate the radiotelephone 400 as the APM 504 in the USB overlay protocol in order to advantageously communicate successfully with the accessories. For example, the PIM will have a memory location for storing a phone number. This information would be associated with a functional address in the PIM and the radiotelephone would need to retrieve this information via the functional address when selecting the desired phone number from the PIM. A second functional address within the PIM may be associated with a URL or another phone number or an pertinent data a radiotelephone may typically incorporate into its operation. This allows the APM 504 to communicate with the device based on both the physical address of the device and the functional address 608 depending on the desired function the APM 504 wishes to execute. Multiple non-unique devices such as multiple smart handsets are supported by the functional address 608 as the same functional address 608 may be represented in multiple physical devices. For example, multiple smart handsets may be cascadedly connected to the APM. Each smart handset has the same functional address 608 representing a given function, such as the display. When the APM 504 send a data set to the display functional address, the data is displayed on both smart handsets 606.

The functional address 608 can be associated with any number of behaviors the APM would want to control, manage or initiate. For example, the APM may be a mobile telephone in an automobile, which in many cases is located in the trunk or some location not readily accessible due to size and or esthetics. The transceiver and logical portions of the mobile unit would be connected via the accessory protocol to the smart handset 606, which is located by the user. Functional addresses would represent the multiple functions of the user interface, a speaker, microphone, or other functions associated with the operation of a mobile telephone.

Other examples of accessories that may be connected or cascaded to the radiotelephone include but are not limited to Personal Information Managers (PIM), hands free car kits, smart handsets, computers, personal digital assistants, Bluetooth™ devices, all which will need to communicate with the subscriber unit in order to function properly.

The physical address is dynamic (i.e. changes upon each connection of the device to the host) and as a result is assigned upon connection of the slave device to the system during initialization or setup of the system. The functional address however 608 is advantageously permanently assigned to a behavior or function. During initialization, the physical address is assigned and then correlated to the functional addresses representing the physical device. A correlation or routing table is then stored in the USB host 502 so that when the APM 504 initiates a transaction, the functional address 608 can be correlated to the intended physical address 610 for routing purposes. As a result, the slave device carries at least two addresses, one physical address assigned by the host 502 to the physical device, and the functional address 608, which is permanently assigned to a behavior or function of the given slave device.

Turning to FIG. 7, the code sequence 700 is shown in accordance with the preferred embodiment of the present invention. This code sequence 700 advantageously includes the functional address 608 of the present invention into the data portion of the code sequence 700. When the code sequence 700 is received at the router from the APM 504, the functional address is read from the data portion 704.

Moving to FIG. 8, a flow chart illustrates the initialization of the cellular radiotelephone as the APM 504 to the host (502, 604). In step 802 the host (502, 604) checks for the connection of an APM 504. If there is a new APM 504 then the host will perform a reset function 806. In step 808 the host (502, 604) assigns a physical address 610 to the APM 504. Next 810, the host (502, 604) will request the device descriptor. In order to determine whether or not the APM 504 is compatible with the host, the host (502, 604) examines the device descriptor vendor information. The host makes a decision 812 whether or not the code is acceptable or not. If the code is acceptable, the APM 504 is configured in step 816. Once the APM 504 is configured the host (502, 604) will poll the APM 504 for accessory data containing accessory commands. If the APM 504 does not have data 820, the host (502, 604) will move back to step 818 and continue to poll for accessory data. If the APM 504 does have data 820, the host moves to the next step and checks for the attach command 822. If there is no attach command, the host loops back to 818 and subsequently polls the APM 504 for accessory data. If the attach command is available 822, the host will store the functional address and the physical address of the APM 504 in the routing database 824.

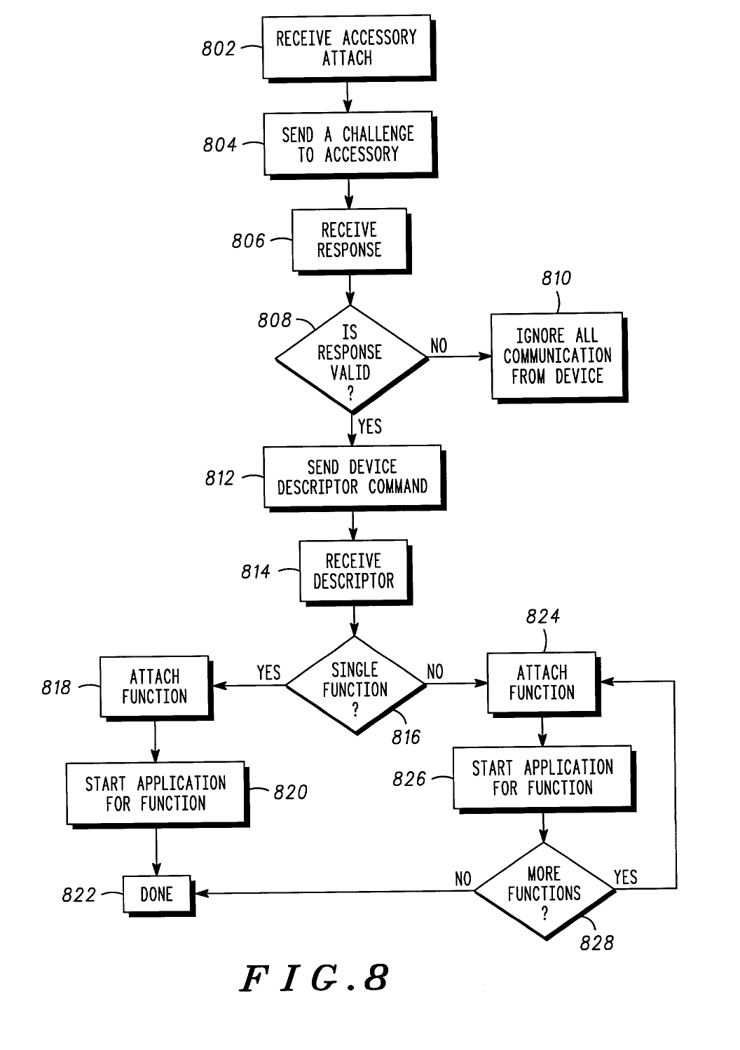

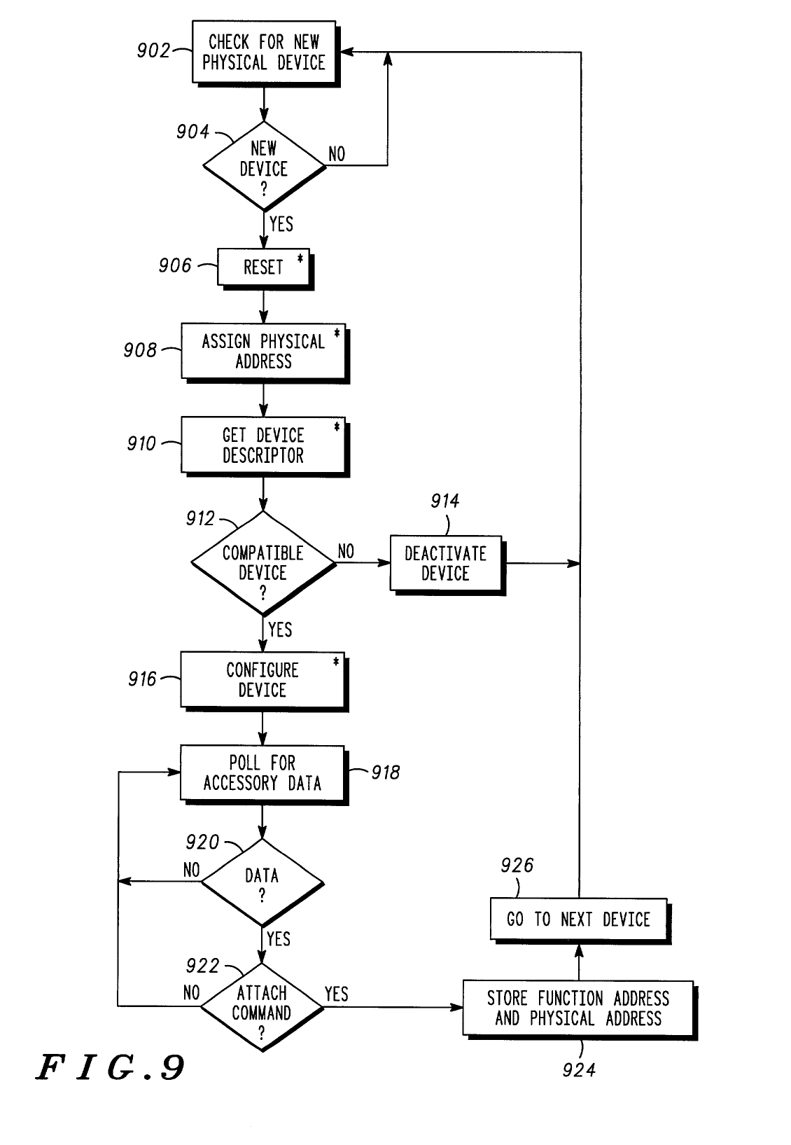

Once the APM 504 has been initialized with the host, the slave device must advantageously initialize with the APM 504 of the preferred embodiment of the present invention. Moving to FIG. 9, a flow chart describing the initialization of a slave device of the present invention or an accessory of the preferred embodiment of the present invention with the APM 504 is shown. The first step in initializing the accessory with the APM 504 is for the APM 504 to receive the accessory attached command 902. The APM 504 will respond by sending the accessory a challenge 904. The Accessory will respond with an answer to the challenge 906 and the APM 504 will verify the challenge 908. If the challenge is appropriate the APM 504 will request from the accessory the device descriptor 912, which is then sent by the accessory 914. If a single function is received 916 the APM 504 will attach the function 918 start the application for that function 920. If multiple functions are received 916, the APM 504 will attach the function 924, start the application for that function 926, and then attach the next function 924 until all functions are attached and their respective addresses are received 922. At this point, the APM 504 may communicate with all connected accessories.

In an alternative embodiment to accommodate the most flexibility in the host operation, all devices must match the destination logical address in all received command packets against the logical addresses they support. If the destination address does not match the device shall ignore the message. This allows the host to choose between explicit routing of messages based on the subaddress or broadcasting all messages to all devices. For example, if two devices of the same type are attached to the system (i.e. two handsets are attached) the host will send all data to the addresses to that logical address to both physical devices.

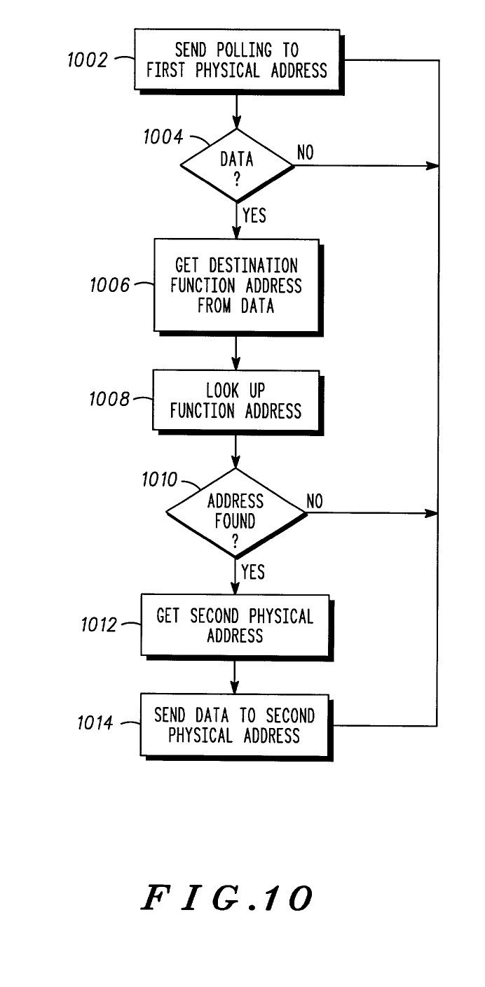

Turning to FIG. 10 a flow chart showing the general control of a transaction by the APM 504 in accordance with the preferred embodiment of the present invention is shown. The APM 504 may begin to control transactions to and from the accessory. To begin the sequence the host will poll the APM 504 located at a first physical address 1002. If the APM 504 has a data set to be sent to a slave or accessory, the APM 504 will reply with a second message which includes the data to be delivered and the functional address of the desired delivery location. The functional address is provided in the header portion of the data and designates the final destination of the data set. The second message is received at the router. The functional address 608 is retrieved from the second message 1006 and correlated 1008 to a second physical 1012 address stored within the routing database. A third message is generated comprising the second physical address, the functional address, and the first data set from the APM 504. This message is then forwarded to the second physical address where the first data set is delivered to the functional address 1014.

As mentioned earlier, multiple types of transactions that are standards to the USB are carried out under the accessory protocol as well. These include the control data, requesting data, or download data. The method of the preferred embodiment of the present invention is shown in the following data sequence showing the setup phase, the data phase and the status phase.

Register device detailed example

| SETUP | | |
|---|---|---|
| DATA0 | | Setup Phase |
| bmRequestType IN | | Data Poll |
| bRequest | | |
| wValue | | |
| wIndex | | |
| wLength | | |
| IN | SU to host | |
| | DATA1 | Data Phase |
| | Low-level protocol | |
| | SU address | |
| | HS_ROOT addr | |
| | Reserved | |
| | Get_Descriptor | |
| | EOP | |
| Host to SU | | |
| ACK | | Status Phase |
| Host to Accy | | |
| SETUP | | |
| DATA0 | | |
| bmRequestType OUT | | Forwarded |
| bRequest | | data for |
| wValue | | Accy |
| wIndex | | |
| wLength | | |
| OUT | | |
| DATA1 | | |
| Low-level protocol | | |
| SU address | | |
| HS_ROOT addr | | |
| Reserved | | |
| Get_Descriptor | | |
| EOP | | |

ACCY to host
ACK

| | |
|---|---|
| Host to ACCY | |
| SETUP | |
| DATA0 | Data Poll |
| bmRequestType IN | |
| bRequest | |
| wValue | |
| wIndex | |
| wLength | |
| IN | |

ACCY to host
DATA1
Low-level protocol - Resp
SU address
HS_ROOT addr
Reserved
Get_Descriptor
<Descriptor data>
EOP

There are many specific transactions that may occur, but some common examples following this data flow include, retrieving phone number from address book in the PIM accessory and storing the number in the phone for dialing;

The present invention further allows the APM 504 or cell phone in the preferred embodiment of the present invention to control the power management of the entire system. Because the cell phone in many cases is powered by a battery, it is beneficial for the battery to monitor and control power usage to prolong the battery life as much as possible. With the present invention, the phone in response to battery characteristics can send commands to the entire system that prolong battery life in the most efficient manner. Likewise any other accessory can wake up the system when the situation renders it necessary to do so.

The preferred embodiment of the present invention further allows accessories and other external host devices to be advantageously cascaded. In the present invention this allows for example an external computer to pass data through the host device to the cell phone. The computer can use certain phone interfaces as if it were connected directly to the phone. The external computer can also appear as another accessory device that would be controlled by the phone. Another example would be a cell phone or APM 504 attached to a host, which would be attached to another host, which would be attached to another computer.

Although the invention has been described and illustrated in the above description and drawings, it is understood that this description is by way of example only and that numerous changes and modifications can be made by those skilled in the art without departing from the true spirit and scope of the invention. For example, although the USB protocol is used in the preferred embodiment of the presenting invention, the master slave protocol may be that of the Bluetooth™ protocol HDLC, or other common master slave networks. Although the present invention finds particular use in portable cellular radiotelephones, the invention could be applied to any wireless communication device, including pagers, electronic organizers, as well as any electronic device or computer requiring the need to communicate directly over a master slave protocol with other slave devices. Applicant's invention should be limited only by the following claims:

1. A method for peer to peer communication over an inherently master/slave network which includes a host device and at least one slave device, the method comprising the steps of:
transmitting a first message from said host device to a slave device, said slave device having a first physical address, said first message requesting a data set from said slave device;
transmitting a second message from said slave device to said host device, wherein said second message contains a functional address that is the true destination for said data set and wherein said second message comprises said data set;
determining, within said host device, a second physical address associated with said functional address of said second message; and
transmitting a third message in response to said second message from said host device to said second physical address, said third message having said second physical address and said data set of said second message.

2. The method of claim 1 wherein the step of transmitting said second message is in response to said step of transmitting said first message.

3. The method of claim 1 wherein said first slave device has a transceiver.

4. The method of claim 1 wherein said second physical address represents a second slave device.

5. The method of claim 1 wherein the second physical address represents said host device.

6. The method of claim 5 wherein said second slave device is a wireless communication device accessory.

7. The method of claim 1 wherein said functional address correlates to a plurality of physical addresses.

8. The method of claim 1 wherein said first message sent by said host device is sent to said plurality of devices connected to said host.

9. The message of claim 1 wherein said second message further comprises a data phase and wherein said functional address is inserted into a header of said data phase.

10. The method of claim 5 wherein said first functional address corresponds to a first memory location within said second slave device.

11. The method of claim 10 wherein said first memory location is associated with a first function of said second slave device.

12. The method of claim 1 wherein said second physical address transmits a fourth message in response to said data set of said second message, to said first physical address.

13. The method of claim 1 wherein said host device is connected to a second host device

14. The method of claim 1 wherein a plurality of host devices may be cascadedly connected to said host device and wherein said second message is forwarded though said plurality of host devices until said true destination designated by said functional address is reached.

15. The method of claim 1 wherein said slave device transmits a power management command to at least one accessory.

16. The method of claim 15 wherein said at least one accessory may transmit a power management command requesting to wake up the system.

17. The method of claim 15 wherein said power management command is a request to activate in said at least one accessory a first mode, wherein said first mode is operative to conserve power consumption by the system.

18. A method for allowing a wireless communication device to act as a master device under the USB master/slave protocol and control transactions between said wireless communication device and an accessory connected to said wireless communication device, the method comprising the steps of:
sending a USB message from a USB host device to the wireless communication device having a first physical address;
sending a second USB message in response to said first USB message from said wireless communication device to said USB host, said second USB message containing a first functional address in said data portion of said second USB message corresponding to an endpoint within said accessory;
determining a second physical address associated with said first functional address within a router of said USB host device, wherein said second physical address corresponds to said accessory;
sending a third USB message from said USB host device to said second physical address;
sending said third USB message to said first functional address of said second physical address.

19. The method of claim 18 wherein said accessory is a plurality of wireless communication device accessories.

20. A method for peer to peer communication over the Universal Serial Bus (USB) which has connected thereto a host device, a communication device, and a communication accessory device, the method comprising the steps of:
receiving a first message from said host device at said communication device, said communication device having a first physical address, said first message requesting a data set from said communication device;
transmitting a second message from said communication device to said host device, wherein said second message comprises a functional address that is the true destination for said data set and wherein said second message further comprises said data set;
determining, within said host device, a second physical address associated with said functional address of said second message,
wherein said second physical address represents said communication accessory device; and
transmitting a third message in response to said second message from said host device to said communication accessory device, said third message having said second physical address and said data set of said second message.
